(19) United States
(12) Patent Application Publication
(10) Pub. No.: US 2025/0112889 A1
(43) Pub. Date: Apr. 3, 2025

(54) WIRELESS COMMUNICATION SCHEMES FOR SUPPORTING CONNECTIONS WITH INTERNET PROTOCOL

(71) Applicant: ZTE Corporation, Shenzhen (CN)

(72) Inventors: Menghan WANG, Shenzhen (CN); Shuang LIANG, Shenzhen (CN); Jinguo ZHU, Shenzhen (CN); Xingyue ZHOU, Shenzhen (CN)

(21) Appl. No.: 18/979,276

(22) Filed: Dec. 12, 2024

Related U.S. Application Data
(63) Continuation of application No. PCT/CN2022/119490, filed on Sep. 17, 2022.

(51) Int. Cl. H04L 61/5014; H04W 76/19; H04W 76/20

(52) U.S. Cl. CPC H04L 61/5014; H04W 76/19; H04W 76/20

(57) ABSTRACT

A method of wireless communication is provided. The method comprises: transmitting, by a user device to an access network, a first message to request an Internet protocol (IP) address that is to be used for the wireless communication; and receiving, by the user device from the access network, IP address information including the IP address allocated to the user device.

### CROSS-REFERENCE TO RELATED APPLICATION

This application is a continuation and claims priority to International Application No. PCT/CN2022/119490, filed on Sep. 17, 2022, the disclosure of which is hereby incorporated by reference herein in its entirety.

### TECHNICAL FIELD

This document relates to systems, devices and techniques for wireless communications.

### BACKGROUND

Efforts are currently underway to define next generation wireless communication networks that provide greater deployment flexibility, support for a multitude of devices and services and different technologies for efficient system evolution.

### SUMMARY

Various methods and apparatus for supporting Non-Access Stratum (NAS) protocol in a wireless communication system are provided.

In one example aspect, a method of wireless communication is disclosed. The method includes transmitting, by a user device to an access network, a first message to request an Internet protocol (IP) address that is to be used for the wireless communication; and receiving, by the user device from the access network, IP address information including the IP address allocated to the user device.

In another example aspect, another method of wireless communication is disclosed. The method includes receiving, by an access network, a first message to request an Internet protocol (IP) address that is to be used for the wireless communication; allocating, by the access network, the IP address to the user device; and transmitting, by the access network to a user device, IP address information including the IP address allocated to the user device.

In yet another example aspect, a wireless communications apparatus comprising a processor is disclosed. The processor is configured to implement methods described herein.

In another example aspect, the various techniques described herein may be embodied as processor-executable code and stored on a computer-readable program medium.

The details of one or more implementations are set forth in the accompanying drawings, and the description below. Other features will be apparent from the description and drawings, and from the claims.

### BRIEF DESCRIPTION OF THE DRAWINGS

FIG. 1 shows an example architecture to which various embodiments can be applied.

FIG. 2 shows an example of a control plane protocol stack between a UE and an AMF.

FIG. 3 shows an example of a control plane protocol stack between a UE and an AN (access network) based on some implementations of the disclosed technology.

FIG. 4 shows an example procedure of an IP address allocation during RRC connection establishment procedure based on some implementations of the disclosed technology.

FIG. 5 shows an example procedure of an IP address allocation during a handover procedure based on some implementations of the disclosed technology.

FIG. 6 shows an example procedure for of an IP address release during a RRC connection release procedure based on some implementations of the disclosed technology.

FIG. 7 is a block diagram of an example of a wireless communication apparatus.

FIG. 8 shows an example wireless communications network.

FIGS. 9 and 10 are example flowcharts of wireless communication methods based on some implementations of the disclosed technology.

### DETAILED DESCRIPTION

Section headings are used in the present document only to improve readability and do not limit scope of the disclosed embodiments and techniques in each section only to that section. Furthermore, some embodiments are described with reference to Third Generation Partnership Project (3GPP) New Radio (NR) standard (“5G”) for ease of understanding and the described technology may be implemented in different wireless system that implement protocols other than the 5G protocol.

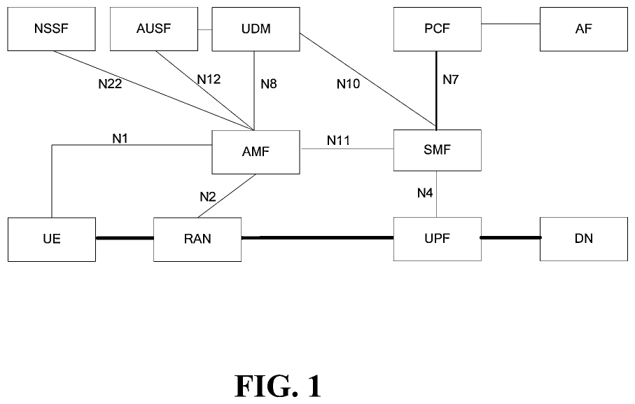

FIG. 1 shows an example architecture to which various embodiments of the disclosed technology can be applied. The example architecture as shown in FIG. 1 corresponds to a 5G system (5GS) architecture that includes following network functions (NFs):

1) UE, User Equipment.

2) RAN, Radio Access Network.

3) AMF, Access and Mobility Management Function. This NF includes functionalities such as UE Mobility Management, Reachability Management, Connection Management and Registration Management. The AMF terminates the RAN Control Plane (CP) interface N2 and NAS interface N1, NAS ciphering and integrity protection. It also distributes the SM NAS to the proper SMFs via N11 interface.

4) UDM, Unified Data Management. This NF manages the subscription profile for the UEs. The subscription data is stored in the Unified Data Repository (UDR). The subscription information includes the network slice related subscription data used for Mobility Management and Session Management. The AMF and SMF retrieve the subscription data from the UDM.

5) NSSF, Network Slice Selection Function. This NF supports the following functionality: selecting the set of Network Slice instances serving the UE; determining the Allowed NSSAI and, if needed, the mapping to the HPLMN S-NSSAIs; determining the Configured NSSAI and, if needed, the mapping to the HPLMN S-NSSAIs; determining the AMF Set to be used to serve the UE, or, based on configuration, a list of candidate AMF(s), possibly by querying the Network Repository Function (NRF).

6) SMF, Session Management Function. This NF includes the following functionalities: session establishment, modification and release, UE IP address allocation & management, selection and control of user plane (UP) function, etc.

7) UPF, User Plane Function. This NF serves as an anchor point for intra-/inter-radio access technology (RAT) mobility and as the external PDU session point of interconnect to Data Network (DN). The UPF also routes and forwards the data packet according to the indication from the SMF. It also buffers the downlink (DL) data when the UE is in idle mode.

8) PCF, Policy Control Function. This NF supports unified policy framework to govern network behavior. The PCF provides access management policy to AMF, or session management policy to SMF, or UE policy to the UE. The PCF can access the UDR to obtain the subscription information relevant for policy decisions.

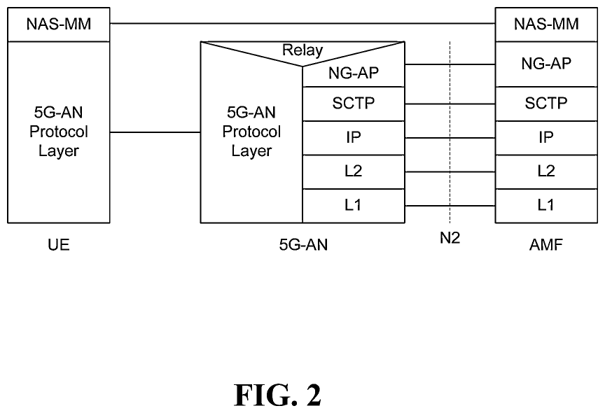

FIG. 2 shows an example of a control plane protocol stack between a UE and an AMF.

The following descriptions can be applied to the NAS-MM and the 5G-AN protocol layer as shown in FIG. 2.

NAS-MM: The NAS protocol for MM (Mobility Management) functionality supports registration management functionality, connection management functionality and user plane connection activation and deactivation. It is also responsible of ciphering and integrity protection of NAS signalling. 5G NAS protocol is defined in 3GPP TS 24.501.

5G-AN Protocol layer: This set of protocols/layers depends on the 5G-AN (Access Network). In the case of NG-RAN (Next Generation-Radio Access Network), the radio protocol between the UE and the NG-RAN node (eNodeB or gNodeB) includes Access Stratum (AS) layer and lower layers and is specified in 3GPP TS 36.300 and 3GPP TS 38.300.

NAS protocol is adopted to establish NAS signalling connection between the UE and the core network. The internal system structure of the terminal includes the operating system (OS) and the modem. Currently, NAS layer is supported in the modem, which means the modem needs to be upgraded whenever a new feature is added in NAS layer. However, modem upgrade is complex and requires long-term evolution.

In recognition of the issues above, various implementations of the disclosed technology provide methods to support NAS over IP (Internet Protocol). With implementations of the disclosed technology, the NAS layer can be supported in the operating system and it is easier to upgrade the operating system to support new features in NAS.

### Example Implementation 1: Control Plane Protocol Stack Between UE and AN

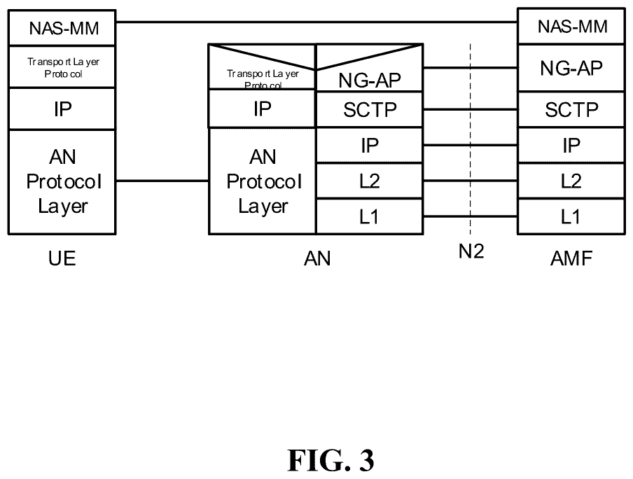

FIG. 3 shows an example of a control plane protocol stack between the UE and the AN. As illustrated in FIG. 3, the implementation of the disclosed technology provides the control plane protocol stack between the UE and the AN, in which the UE and the AN includes an Internet layer and the transport layer. In FIG. 3, the Internet layer and transport layer are inserted between an AN Protocol Layer and a NAS Layer. The Internet layer and the transport layer are supported in the operating system (OS). The protocol for the internet layer is IP. The protocol for Transport Layer can be TCP (Transmission Control Protocol), UDP (User Datagram Protocol), QUIC (Quick UDP Internet Connection) or others. The AN Protocol Layer includes AS layer and lower layers.

### Example Implementation 2: IP Address Allocation During RRC Connection Establishment Procedure

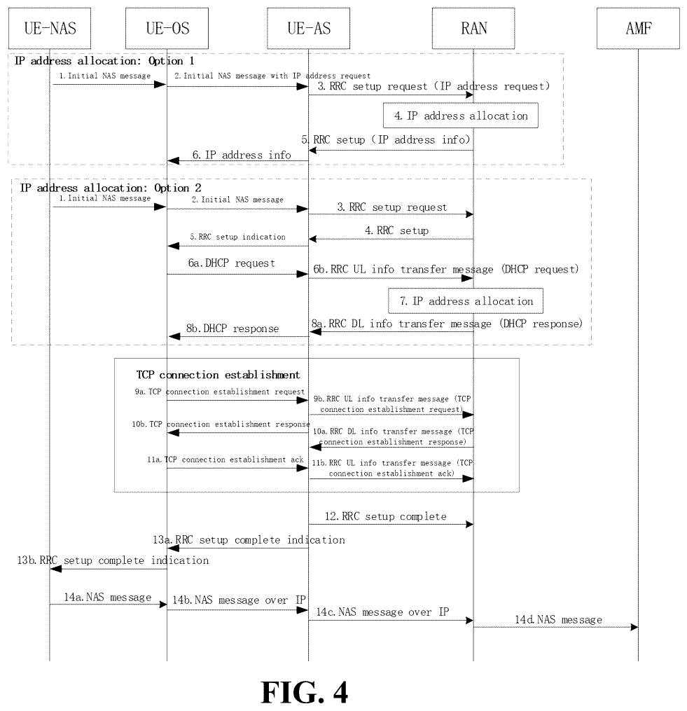

FIG. 4 shows an example procedure of an IP address allocation during RRC connection establishment procedure. In the example of FIG. 4, the UE is divided into a UE-NAS, a UE-OS and a UE-AS, in order to explicitly illustrate the interaction among the UE NAS layer, the UE OS layer and the UE AS layer.

In the example of FIG. 4, there are two options to allocate an IP address to the UE. Thus, one of Option 1 or Option 2 is performed to allocate an IP address to the UE.

### Option 1 for IP Address Allocation:

Operation 1. UE-NAS to UE-OS: The UE NAS layer sends initial NAS message to the UE OS layer.

Operation 2. UE-OS to UE-AS: The UE OS layer forwards the initial NAS message to the UE AS layer, with IP address request indication.

Operation 3. UE-AS to RAN: The UE AS layer initiates RRC connection establishment procedure by transmitting RRC setup request message to the RAN. The RRC setup request message includes an IP address request indication or an indication to indicate the UE capability of support NAS over IP.

Operation 4. RAN: The RAN allocates IP address for the UE.

Operation 5. RAN to UE-AS: The RAN sends a RRC setup response message to the UE AS layer. The RRC setup response message includes IP address information allocated to the UE. The IP address information can include the IP address, the port number, the subnet mask, default gateway, DNS (Domain Name System) server and so on.

Operation 6. UE-AS to UE-OS: The UE AS layer forwards the allocated IP address information to the UE OS layer. After Operation 6, Operation 9 is performed.

### Option 2 for IP Address Allocation:

Operation 1. UE-NAS to UE-OS: The UE NAS layer sends initial NAS message to the UE OS layer.

Operation 2. UE-OS to UE-AS: The UE OS layer forwards the initial NAS message to the UE AS layer.

Operation 3. UE-AS to RAN: The UE AS layer initiates a RRC connection establishment procedure by transmitting a RRC setup request message to the RAN.

Operation 4. RAN to UE-AS: The RAN sends a RRC setup response message to the UE AS layer.

Operation 5. UE-AS to UE-OS: The UE AS layer sends a RRC successful setup indication to the UE OS layer, such that the UE OS layer can request the IP address allocation.

Operation 6a. UE-OS to UE-AS: The UE OS layer transmits an IP address request to the UE AS layer. The IP address request can be, for example, a DHCP (Dynamic Host Configuration Protocol) request message.

Operation 6b. UE-AS to RAN: The IP address request received from the UE OS layer can be included in, for example, RRC UL (Uplink) information transfer message. In some implementations, the IP address request can be included in, for example, UL information transfer message with an indication indicating that the request is for a RRC connection and no NAS payload is contained.

Operation 7. RAN: The RAN allocates the IP address for the UE.

Operation 8a. RAN to UE-AS: The RAN sends allocated IP address information to the UE AS layer. The allocated IP address information can be, for example, a DHCP response message. The allocated IP address information can be included in, for example, a RRC DL (Downlink) information transfer message. In some implementations, the allocated IP address information can be included in, for example, a DL information transfer message with an indication indicating that the response is for a RRC connection and no NAS payload is contained. The IP address information can include at least one of the IP address, the port number, the subnet mask, default gateway, DNS (Domain Name System) server and so on.

Operation 8b. UE-AS to UE-OS: The UE AS layer forwards the allocated IP address information to the UE OS layer. After Operation 8b, Operation 9 is performed.

After the successful IP address allocation, the transport layer connection can be established. While there exist many transport layer protocols that can be adopted, TCP is described as an example in the below description. However, other implementations are also possible.

### TCP Connection Establishment:

Operation 9a. UE-OS to UE-AS: The UE OS layer initiates a TCP connection establishment procedure by transmitting a TCP connection establishment request to the UE AS layer.

Operation 9b. UE-AS to RAN: The TCP connection establishment request can be included in, for example, the RRC UL information transfer message, or included in, for example, the UL information transfer message with an indication indicating that the request is for the RRC connection and no NAS payload is contained.

Operation 10a. RAN to UE-AS: The RAN sends TCP connection establishment response message to the UE AS layer indicating that new TCP connection can be established. The TCP connection establishment response message can be included in, for example, the RRC DL information transfer message, or included in, for example, the DL information transfer message with an indication indicating that the response is for RRC connection and no NAS payload is contained.

Operation 10b. UE-AS to UE-OS: The UE AS layer forwards the received TCP connection establishment response message to the UE OS layer.

Operation 11a. UE-OS to UE-AS: The UE OS layer sends TCP connection establishment acknowledgement message to confirm the successful reception of TCP connection establishment response message from the RAN.

Operation 11b. UE-AS to RAN: The TCP connection establishment acknowledgement message can be included in, for example, the RRC UL information transfer message, or included in, for example, the UL information transfer message with an indication indicates that the request is for RRC connection and no NAS payload is contained.

After successful IP address allocation and TCP connection establishment, the following operations are performed:

Operation 12. UE-AS to RAN: The UE AS layer sends a RRC setup complete message to the RAN to confirm the successful completion of RRC connection establishment. The initial NAS message may be piggybacked in the RRC setup complete message and sent to AMF.

Operation 13a. UE-AS to UE-OS: The UE AS layer sends a RRC setup complete indication to the UE OS layer.

Operation 13b. UE-OS to UE-NAS: The UE OS layer forwards the RRC setup complete indication to the UE NAS layer.

Operation 14a. UE-NAS to UE-OS: The UE NAS layer sends a NAS message to the UE OS layer.

Operation 14b. UE-OS to UE-AS: The UE OS layer forwards the NAS message over the allocated IP address to the UE AS layer.

Operation 14c. UE-AS to RAN: The UE AS layer forwards the NAS message over the allocated IP address to the RAN.

Operation 14d. RAN to AMF: The RAN forwards the received NAS message to the AMF.

### Example Implementation 3: IP Address Allocation During RRC Connection Resume Procedure

This implementation discusses allocating an IP address during a RRC connection resume procedure. In this implementation for the RRC connection resume procedure, the IP address allocation and the transport layer connection establishment are similar to those discussed in the Example Implementation 2. Specifically, for the IP address allocation during the RRC connection resume procedure, the Operations 1 to 14d as those described in the Example Implementation 2 are performed while the differences 1) to 4) below are applied. The same description is omitted and only differences 1) to 4) are discussed in the following description.

1) The initial NAS message is replaced by NAS message.

2) The RRC setup request message is replaced by RRC resume request message.

3) The RRC setup message can be replaced by RRC resume message.

4) The RRC setup complete message can be replaced by RRC resume complete message.

### Example Implementation 4: IP Address Allocation During Handover Procedure

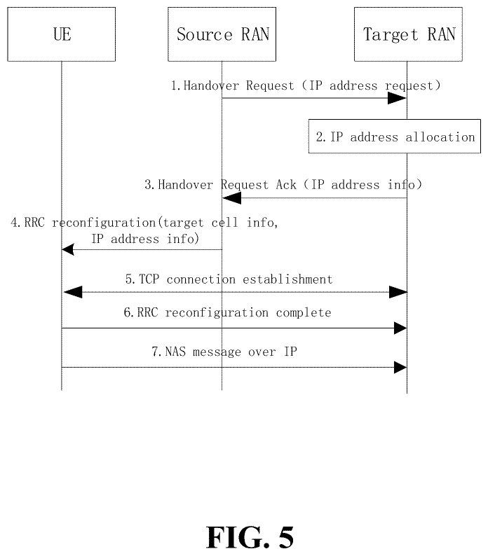

FIG. 5 shows an example procedure of an IP address allocation during a handover procedure based on some implementations of the disclosed technology.

Operation 1. Source RAN to Target RAN: The source RAN decides to handover the UE to the target RAN based on a measurement report and RRM (Radio Resource Management) information. The source RAN issues a handover request message to the target RAN passing a transparent RRC container with necessary information to prepare the handover at the target side. The information includes IP address request indication or an indication indicates the UE capability of support NAS over IP.

Operation 2. Target RAN: The target RAN allocates an IP address for the UE.

Operation 3. Target RAN to Source RAN: The target RAN prepares the handover and sends handover request acknowledge to the source RAN, which includes a transparent container to be sent to the UE as an RRC message to perform the handover. The information includes IP address information allocated to the UE. The IP address information can include the IP address, the port number, the subnet mask, default gateway, DNS (Domain Name System) server and so on.

Operation 4. Source RAN to UE: The source RAN sends RRC reconfiguration message to the UE, containing the information required to access the target access network. The information includes the target access network information and the allocated IP address information.

Similar like Example 2, here take TCP as transport layer protocol example.

Operation 5. TCP connection is established between the UE and the target RAN. In this implementation, the TCP is described as an example of a transport layer protocol but other implementations are also possible. Operation 5 here can proceed similarly to Operations 9a to 11b of Example Implementation 2.

Operation 6. The UE synchronizes to the target access network and completes the RRC handover procedure by sending RRC Reconfiguration Complete message to target RAN.

Operation 7. The UE sends NAS message over the allocated IP address to the target RAN.

### Example Implementation 5: IP Address Release During RRC Connection Release Procedure

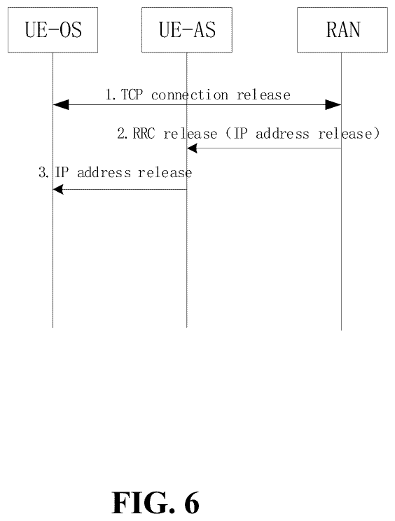

FIG. 6 shows an example procedure for of an IP address release during a RRC connection release procedure based on some implementations of the disclosed technology. In this implementation, a TCP is described as an example of a transport layer protocol but other implementations are also possible.

Operation 1. The TCP connection established between the UE and the RAN is released. Steps 9a-11b in Example 2 are three times handshake for TCP connection establishment. In this example, four times wave is used for TCP connection release.

Operation 2. RAN to UE-AS: The RAN initiates RRC connection release procedure to release the RRC connection between the UE and the RAN. The RAN sends RRC release message to the UE AS layer. The RRC release message includes IP address release indication. The RAN releases the IP address allocated for the UE.

Operation 3. UE-AS to UE-OS: The UE AS layer forwards the IP address release indication to the UE OS layer. The UE releases the IP address allocated for the UE.

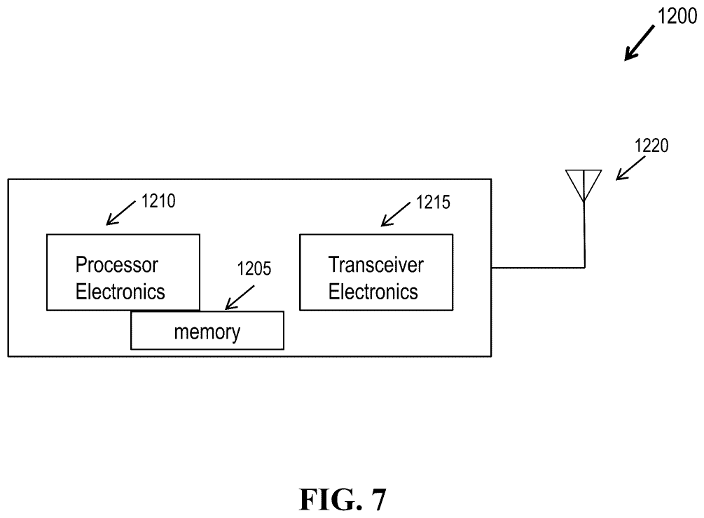

FIG. 7 is a block diagram of an example implementation of a wireless communication apparatus 1200. The methods described herein may be implemented by the apparatus 1200. In some embodiments, the apparatus 1200 may be a base station or a network device of a wireless network. In some embodiments, the apparatus 1200 may be a user device (e.g., a wireless device or a user equipment UE). The apparatus 1200 includes one or more processors, e.g., processor electronics 1210, transceiver circuitry 1215 and one or more antenna 1220 for transmission and reception of wireless signals. The apparatus 1200 may include memory 1205 that may be used to store data and instructions used by the processor electronics 1210. The apparatus 1200 may also include an additional network interface to one or more core networks or a network operator's additional equipment. This additional network interface, not explicitly shown in the figure, may be wired (e.g., fiber or Ethernet) or wireless.

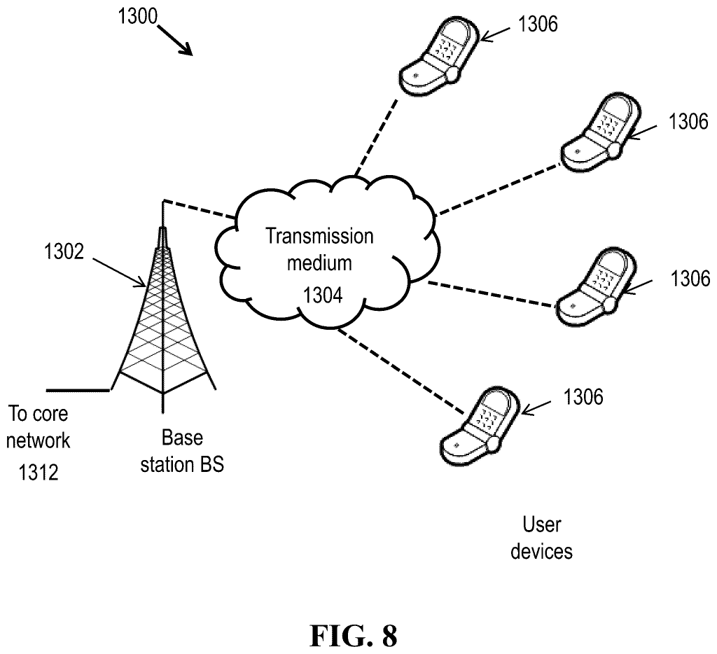

FIG. 8 depicts an example of a wireless communication system 1300 in which the various techniques described herein can be implemented. The system 1300 includes a base station 1302 that may have a communication connection with core network (1312) and to a wireless communication medium 1304 to communicate with one or more user devices 1306. The user devices 1306 could be smartphones, tablets, machine to machine communication devices, Internet of Things (IoT) devices, and so on.

Some preferred embodiments may include the following solutions.

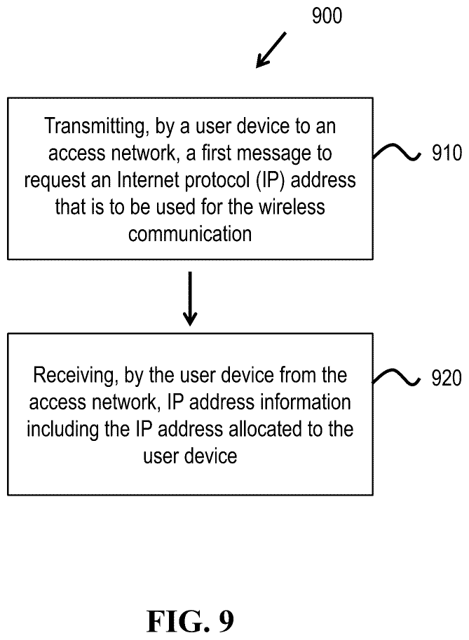

1. A method of wireless communication (e.g., method 900 as shown in FIG. 9), comprising: transmitting 910, by a user device to an access network, a first message to request an Internet protocol (IP) address that is to be used for the wireless communication; and receiving 920, by the user device from the access network, IP address information including the IP address allocated to the user device.

2. The method of solution 1, further comprising, after receiving the IP address information: transmitting, by the user device to the access network, a second message to request a transport layer connection establishment; and receiving, by the user device from the access network, a connection establishment response message indicating an establishment of a transport layer connection.

3. The method of solution 1, wherein the first message is a radio resource control (RRC) set up request message or a RRC resume request message that includes a first indication to request for the IP address or a second indication to indicate a device capability of supporting a non-access stratum (NAS) over an IP.

4. The method of solution 1, wherein the first message is a RRC uplink (UL) information transfer message including a dynamic host configuration protocol (DHCP) request message.

5. The method of solution 1, wherein the first message is a uplink (UL) information transfer message that includes a dynamic host configuration protocol (DHCP) request and an indication indicating that the request is for a RRC connection and no non-access stratum (NAS) payload is contained.

6. The method of solution 1, wherein the IP address information is included in a RRC setup response message, a RRC resume response message, or a RRC reconfiguration message.

7. The method of solution 1, wherein the IP address information is included in a DHCP response message included in a RRC downlink (DL) information transfer message, or the IP address information is included in a DHCP response message included in a DL information transfer message which also includes an indication indicating that a response is for a RRC connection and no NAS payload is contained.

8. The method of any of solutions 1 to 7, wherein the IP address information further includes a port number, a subnet mask, a default gateway, DNS server information.

9. The method of solution 2, wherein the second message is included in a RRC UL information transfer message or included in a UL information transfer message with an indication indicating that the request is for RRC connection and no NAS payload is contained.

10. The method of solution 2, wherein the connection establishment response message is included in a RRC downlink (DL) information transfer message, or included in a DL information transfer message including an indication indicating that a response is for a RRC connection and no NAS payload is contained.

11. The method of solution 2, further comprising: transmitting, in response to receiving the connection establishment response message, to the access network, a connection establishment acknowledgement message that is included a RRC UL information transfer message or included in a UL information transfer message with an indication indicating that a corresponding request is for RRC connection and no NAS payload is contained.

12. The method of solution 1, further comprising: transmitting, to the access network, a NAS message over the IP address.

13. The method of solution 1, further comprising: receiving a reconfiguration message including target access network information that allows the user device to access a target access network and another IP address information allocated by the target access network.

14. The method of solution 13, further comprising: establishing a transport layer connection with the target access network; and sending a NAS message over the another IP address allocated by the target access network to the target access network.

15. The method of solution 1, further comprising: receiving, from the access network, a RRC release message including an indication to release the IP address; and releasing the IP address in response to receiving of the RRC release message.

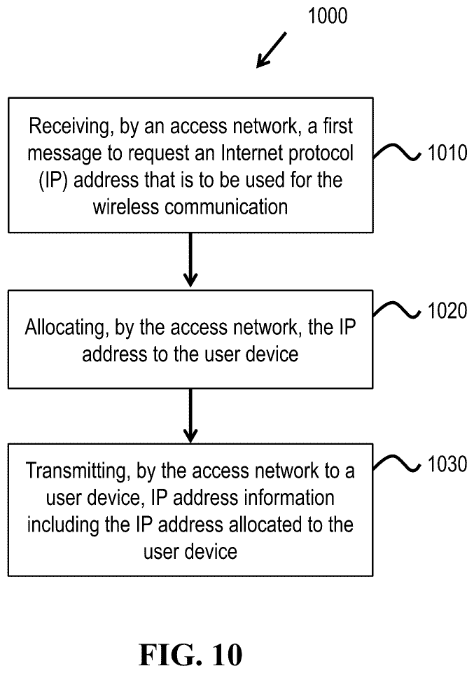

16. A method of wireless communication (e.g., method 1000 as shown in FIG. 10), comprising: receiving 1010, by an access network, a first message to request an Internet protocol (IP) address that is to be used for the wireless communication; allocating 1020, by the access network, the IP address to the user device; and transmitting 1030, by the access network to a user device, IP address information including the IP address allocated to the user device.

17. The method of solution 16, further comprising, after transmitting the IP address information: receiving, by the access network from the user device, a second message to request a transport layer connection establishment; and transmitting, by the access network to the user device, a connection establishment response message indicating an establishment of a transport layer connection.

18. The method of solution 16, wherein the first message is a RRC set up request message or a RRC resume request message that includes a first indication to request for the IP address or a second indication to indicate a device capability of supporting NAS over an IP.

19. The method of solution 16, wherein the first message is a RRC uplink (UL) information transfer message including a dynamic host configuration protocol (DHCP) request message.

20. The method of solution 16, wherein the first message is a uplink (UL) information transfer message that includes a dynamic host configuration protocol (DHCP) request and an indication indicating that the request is for a RRC connection and no NAS payload is contained.

21. The method of solution 16, wherein the IP address information is included in a RRC setup response message, a RRC resume response message, or a RRC reconfiguration message.

22. The method of solution 16, wherein the IP address information is included in a DHCP response message included in a RRC downlink (DL) information transfer message, or the IP address information is included in a DHCP response message included in a DL information transfer message which also includes an indication indicating that a response is for a RRC connection and no NAS payload is contained.

23. The method of any of solutions 16 to 22, wherein the IP address information further includes a port number, a subnet mask, a default gateway, DNS server information.

24. The method of solution 17, wherein the second message is included in a RRC UL information transfer message or included in a UL information transfer message with an indication indicating that the request is for RRC connection and no NAS payload is contained.

25. The method of solution 17, wherein the connection establishment response message is included in a RRC downlink (DL) information transfer message, or included in a DL information transfer message including an indication indicating that a response is for a RRC connection and no NAS payload is contained.

26. The method of solution 17, further comprising: receiving, in response to transmitting the connection establishment response message, from the user device, a connection establishment acknowledgement message that is included a RRC UL information transfer message or included in a UL information transfer message with an indication indicating that a corresponding message is for RRC connection and no NAS payload is contained.

27. The method of solution 16, further comprising: receiving, from the user device, a NAS message over the IP address.

28. The method of solution 16, further comprising: transmitting, by the access network to the user device, a reconfiguration message including target access network information that allows the user device to access a target access network and another IP address information allocated by the target access network.

29. The method of solution 16, wherein the first message corresponds to a handover request message from a source access network and the method further comprises: transmitting, by the access network to the source access network, a handover request acknowledge message including target access network information and the IP address information allocated for the user device; establishing a transport layer connection between the user device and the access network; and receiving, by the access network from the user device, a NAS message over the IP address allocated by the access network.

30. The method of solution 16, further comprising: transmitting, by the access network to the user device, a RRC release message including an indication to release the IP address.

31. A wireless communication apparatus comprising a processor configured to implement a method recited in any of above solutions.

32. A computer storage medium having code stored thereupon, the code, upon execution by a processor, causing the processor to implement a method recited in any of above solutions.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method of wireless communication, comprising:
transmitting, by a user device to an access network, a first message to request an Internet protocol (IP) address that is to be used for the wireless communication;
receiving, by the user device from the access network, IP address information including the IP address allocated to the user device.

2. The method of claim 1, further comprising, after receiving the IP address information:
transmitting, by the user device to the access network, a second message to request a transport layer connection establishment; and
receiving, by the user device from the access network, a connection establishment response message indicating an establishment of a transport layer connection.

3. The method of claim 1, wherein the first message is a radio resource control (RRC) set up request message or a RRC resume request message that includes a first indication to request for the IP address or a second indication to indicate a device capability of supporting a non-access stratum (NAS) over an IP; or
wherein the first message is a RRC uplink (UL) information transfer message including a dynamic host configuration protocol (DHCP) request message; or
wherein the first message is an uplink (UL) information transfer message that includes a dynamic host configuration protocol (DHCP) request and an indication indicating that a corresponding request is for a RRC connection and no non-access stratum (NAS) payload is contained.

4. The method of claim 1, wherein the IP address information is included in a RRC setup response message, a RRC resume response message, or a RRC reconfiguration message, or
wherein the IP address information is included in a DHCP response message included in a RRC downlink (DL) information transfer message, or
wherein the IP address information is included in a DHCP response message included in a DL information transfer message which also includes an indication indicating that a response is for a RRC connection and no NAS payload is contained.

5. The method of claim 1, wherein the IP address information further includes at least one of a port number, a subnet mask, a default gateway, or DNS server information.

6. The method of claim 2, wherein the second message is included in a RRC UL information transfer message or included in a UL information transfer message with an indication indicating that a corresponding request is for RRC connection and no NAS payload is contained, and
wherein the connection establishment response message is included in a RRC downlink (DL) information transfer message, or included in a DL information transfer message including an indication indicating that a response is for a RRC connection and no NAS payload is contained.

7. The method of claim 2, further comprising:
transmitting, in response to receiving the connection establishment response message, to the access network, a connection establishment acknowledgement message that is included a RRC UL information transfer message or included in a UL information transfer message with an indication indicating that a corresponding request is for RRC connection and no NAS payload is contained.

8. The method of claim 1, further comprising one or more of following:
transmitting, to the access network, a NAS message over the IP address;
receiving a reconfiguration message including target access network information that allows the user device to access a target access network and another IP address information allocated by the target access network;
establishing a transport layer connection with the target access network; or
sending a NAS message over the another IP address allocated by the target access network to the target access network.

9. The method of claim 1, further comprising:
receiving, from the access network, a RRC release message including an indication to release the IP address; and
releasing the IP address in response to receiving of the RRC release message.

10. A method of wireless communication, comprising:
receiving, by an access network, a first message to request an Internet protocol (IP) address for a user device that is to be used for the wireless communication;
allocating, by the access network, the IP address to the user device; and
transmitting, by the access network to the user device, IP address information including the IP address allocated to the user device.

11. The method of claim 10, further comprising, after the transmitting of the IP address information:
receiving, by the access network from the user device, a second message to request a transport layer connection establishment; and
transmitting, by the access network to the user device, a connection establishment response message indicating an establishment of a transport layer connection.

12. The method of claim 10, wherein the first message is a RRC set up request message or a RRC resume request message that includes a first indication to request for the IP address or a second indication to indicate a device capability of supporting NAS over an IP, or
wherein the first message is a RRC uplink (UL) information transfer message including a dynamic host configuration protocol (DHCP) request message, or
wherein the first message is a uplink (UL) information transfer message that includes a dynamic host configuration protocol (DHCP) request and an indication indicating that a corresponding request is for a RRC connection and no NAS payload is contained.

13. The method of claim 10, wherein the IP address information is included in a RRC setup response message, a RRC resume response message, or a RRC reconfiguration message, or
wherein the IP address information is included in a DHCP response message included in a RRC downlink (DL) information transfer message, or
wherein the IP address information is included in a DHCP response message included in a DL information transfer message which also includes an indication indicating that a response is for a RRC connection and no NAS payload is contained.

14. The method of claim 10, wherein the IP address information further includes at least one of a port number, a subnet mask, a default gateway, or DNS server information.

15. The method of claim 11, wherein the second message is included in a RRC UL information transfer message or included in a UL information transfer message with an indication indicating that a corresponding request is for RRC connection and no NAS payload is contained, and
wherein the connection establishment response message is included in a RRC downlink (DL) information transfer message, or included in a DL information transfer message including an indication indicating that a response is for a RRC connection and no NAS payload is contained.

16. The method of claim 11, further comprising: receiving, in response to transmitting the connection establishment response message, from the user device, a connection establishment acknowledgement message that is included a RRC UL information transfer message or included in a UL information transfer message with an indication indicating that a corresponding message is for RRC connection and no NAS payload is contained.

17. The method of claim 10, further comprising one or more of following:
receiving, from the user device, a NAS message over the IP address,
transmitting, by the access network to the user device, a reconfiguration message including target access network information that allows the user device to access a target access network and another IP address information allocated by the target access network, or
transmitting, by the access network to the user device, a RRC release message including an indication to release the IP address.

18. The method of claim 10, wherein the first message corresponds to a handover request message from a source access network and the method further comprises:
transmitting, by the access network to the source access network, a handover request acknowledge message including target access network information and the IP address information allocated for the user device;
establishing a transport layer connection between the user device and the access network; and
receiving, by the access network from the user device, a NAS message over the IP address allocated by the access network.

19. A wireless communication apparatus comprising a processor operating as a user device and configured to:
transmit, to an access network, a first message to request an Internet protocol (IP) address that is to be used for a wireless communication;
receive, from the access network, IP address information including the IP address allocated to the user device.

20. The wireless communication apparatus of claim 19, wherein the processor is further configured to:
transmit, to the access network, a second message to request a transport layer connection establishment; and
receive, from the access network, a connection establishment response message indicating an establishment of a transport layer connection.
